(19) United States
(12) Patent Application Publication
(10) Pub. No.: US 2005/0162397 A1
(43) Pub. Date: Jul. 28, 2005

(54) Remote control device having gear button and method for using graphic user interface using the same

(75) Inventors: Bom-jun Kwon, Seoul (KR); Jang-seok Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/029,699

(22) Filed: Jan. 6, 2005

(30) Foreign Application Priority Data
Jan. 14, 2004 (KR) 10-2004-0002650

(51) Int. Cl. G09G 5/00

(52) U.S. Cl. 345/169

(57) ABSTRACT

A remote control device having a general button unit including a keypad and a matrix circuit part for outputting a desired signal according to an operation of the keypad. A gear unit is provided that includes a rotary gear and a gear circuit part for outputting a desired signal according to a rotation operation of the gear. A control unit generates an electronic equipment control signal according to the signal outputted from the matrix circuit part and the gear circuit part. A transmission unit externally transmits the signal generated in the control unit. Therefore, the gear of the remote control device can conveniently be used to control electronic appliances.

### CROSS-REFERENCE TO RELATED APPLICATION

This application claims priority from Korean Patent Application No. 10-2004-0002650 filed on Jan. 14, 2004 in the Korean Intellectual Property Office, the disclosure of which is incorporated herein by reference.

### BACKGROUND OF THE INVENTION

1. Field of the Invention

Apparatuses and methods consistent with the invention relate to a remote control device having a gear and, more specifically, to a remote control device having a gear wherein the remote control device includes a plurality of function keys in order to remotely control electronic equipment having a remote control function such as, for example, a TV, a set top box, a VCR, a PVR (Personal Video Recorder), and a DVD player.

2. Description of the Related Art

Wireless remote control devices that can send an infrared signal to remotely control electronic equipment, were initially limited to TV, VCR, and A/V equipment, but are now being applied to various pieces of equipment, such as air conditioners, electric fans, etc., as its convenience is recognized.

As the functions of various pieces of equipment are increased due to the development of electronic technology, using a remote control device to remotely control the equipment has become complicated such that it takes a long time to understand the remote control functions. General users use the most basic functions of the remote control device, and even users who are fully aware of all functions do not make sufficient use of them due to there inconvenience and complexity.

On the other hand, it frequently occurs that a user's desired value is to be assigned from items listed sequentially in image electronic appliances. Some examples are to select a desired channel among tens of TV channels, to control volume values from 0 to 100, and to select a desired function from a set menu. While the user has to select such values using various methods provided by the remote control device, conventional devices make it inconvenient to select a user's desired value as explained below.

At first, in the case of a button mode, the user increases or decreases a desired value using general buttons such as a channel moving button and a volume control button. A remote control device requiring such a method is shown in FIG. 1A, which shows a conventional remote control device having a plurality of buttons. Each of the buttons is assigned to perform various functions for operating image appliances, and is devised to perform different functions with one button by operating a mode conversion button 11.

In this case, the user has to push a button such as a channel button 12, a volume button 13 and the like many times in order to move to a desired value (tens or hundreds times, according to circumstances). However, while it may be possible to perform a recurrent input automatically while the button is pushed, it is not possible to move rapidly or finely since the button cannot control the speed, which is automatically inputted. Also, while it may be possible to input a user's desired value directly using number buttons 14, there is a problem in that a user's desired item may correspond to a number and, thus, the user has to memorize the number corresponding to each item. (For example, it is possible to make a rapid movement through a number input only when the user knows all channel numbers through which the user wishes to watch).

FIG. 1B is a view showing a conventional remote control device having a joystick 16, along with various other buttons including a power button, menu button, channel select/volume control button, mute button, screen display button, screen size button, sleep reservation button, PIP button, equipment select button, external input button, Dolby surround button, multi-language button, favorite channel button and still image button. Generally, in the case of displaying a cursor on a screen and desiring to move a two-dimensional position of the cursor, the remote control device of such joystick mode is used to assign a direction of the cursor to be moved.

In the case of the joystick mode, however, it is not possible to control the speed of cursor movement to a desired direction by operating the joystick in the same manner as the button mode. Also, since the joystick 16 is basically used to make a position assignment on a two-dimensional screen, it is seldom used to select values on a one-dimensional space such as channel or volume controls.

FIG. 1C is a view showing a conventional remote control device having a jog shuttle 18. The jog shuttle 18 is conveniently used to control a playback speed of a VCR or DVD player, or to watch scene by scene. Generally, the jog shuttle 18 may be used to change a TV channel. However, while the jog shuttle mode has merit in that the movement is proportional to user's rotation, operational quality and fineness are deteriorated since the user has to operate the jog shuttle 18 on a two-dimensional plane while rotating it.

FIG. 1D is a view showing a conventional remote control device having a jog shuttle and a slider. The remote control device having only a plurality of buttons is equipped with a function mode conversion switch 20 to be slid along with a long hole 21 so that a function mode of the TV can be converted. Also, it is possible to use various functions conveniently by attaching a multi-function key 26 used in each function mode and a jog shuttle dial 23 to the switch. However, such a mode also has almost the same inconvenience as the remote control device of the jog shuttle mode shown in FIG. 1C.

FIG. 2 is a view showing a conventional remote control device having a display 60 and a ball switch 50. This embodiment is related to a remote control device having the display 60 and ball switch 50 wherein equipment is rapidly controlled by enabling all functions of the remote control device to be operable using wheels (41, 42) and a ball switch 50, and a menu system displayed on the remote control device is selected by clicking it. In this embodiment, however, operational quality is deteriorated due to a two-dimensional movement of the ball switch 50, and the remote control device becomes complicated instead of being simple due to the fact that a front part of the device has a display 60.

### SUMMARY OF THE INVENTION

An exemplary aspect of the present invention is to provide a remote control device having a gear and a method for using a graphic user interface using the same wherein a user can precisely assign a desired value while moving slowly by attaching a gear to the remote control device. The user can select a desired item of electronic equipment rapidly and easily, and the cursor can move to a desired value rapidly by rotating the gear at a high speed such that the desired value is reachable by passing many values.

According to an exemplary aspect of the present invention, there is provided a remote control device having a gear, comprising: a general button unit including a desired keypad and a matrix or keypad circuit part for outputting a desired signal according to an operation of the keypad; a gear unit including a desired rotary gear and a gear circuit part for outputting a desired signal according to a rotation speed or angle of the gear; a control unit for generating a desired electronic equipment control signal according to the signals outputted from the matrix circuit part and the gear circuit part; and a transmission unit for externally transmitting the signals generated in the control unit. The gear may have a shape of a wheel or a circular sawtooth.

In an exemplary embodiment, the general button unit includes a first general button part on one side of an upper part of the gear unit and a second general button part on the other side of the upper part of the gear unit. The first general button unit acts to select a desired menu for controlling an operational state of controlled equipment or each item on a graphic user interface, and the second button unit acts to call the menu or the graphic user interface.

In an exemplary embodiment, the gear unit moves a curser or a highlight among the called desired menus or items listed on the graphic user interface according to a rotation direction of the gear, and performs a channel change, a volume control or a screen scroll of the controlled equipment according to the rotation direction of the gear. The cursor or highlight may move by a predetermined interval whenever the gear has a specific rotation angle or the sawtooth of the gear moves one by one. A movement interval of the cursor or highlight may also be changed as the rotation speed of the gear changes.

When an instantaneous rotation speed of the gear exceeds a desired threshold value, the cursor or highlight can continue to move even though there is no more rotation movement of the gear, and the continuous movement of the cursor or highlight is stopped when the gear is pushed or after a lapse of a predetermined time. When the cursor or highlight moves to the end of the menu or to the end of the item listed on the graphic user interface as the gear rotates, hidden items which are not displayed on the menu or graphic user interface are displayed.

According to another exemplary embodiment of the present invention, there is provided a method for using a graphic user interface, including calling the graphic user interface; enabling a cursor or highlight to move among items of the graphic user interface according to a gear rotation direction of a remote control device including a gear; and selecting a desired item.

The cursor or highlight may move by a predetermined interval whenever the gear has a specific rotation angle or the sawtooth of the gear moves one by one. A movement interval of the cursor or highlight can be changed as the rotation speed of the gear changes. When an instantaneous rotation speed of the gear exceeds a desired threshold value, the cursor or highlight may continue to move even though there is no more rotation movement of the gear and, the continuous movement of the cursor or highlight is stopped when the gear is pushed or after a lapse of a predetermined time. In the event that the cursor or highlight moves to the end of the menu or to the end of the item listed on the graphic user interface as the gear rotates, hidden items which are not displayed on the menu or graphic user interface are displayed.

### BRIEF DESCRIPTION OF THE DRAWINGS

The above and other aspects of the present invention will become more apparent to those of ordinary skill in the art by describing in detail exemplary embodiments thereof with reference to the attached drawings in which:

FIG. 1A is a view showing a conventional remote control device having a plurality of buttons;

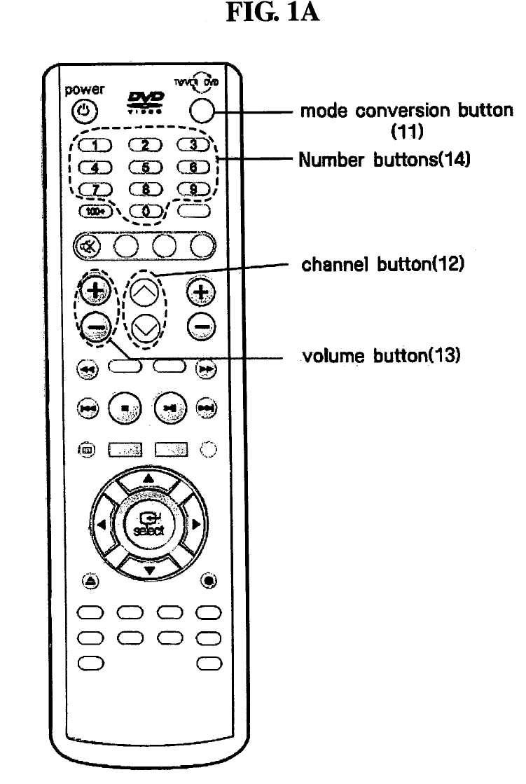

FIG. 1B is a view showing a conventional remote control device having a joystick;

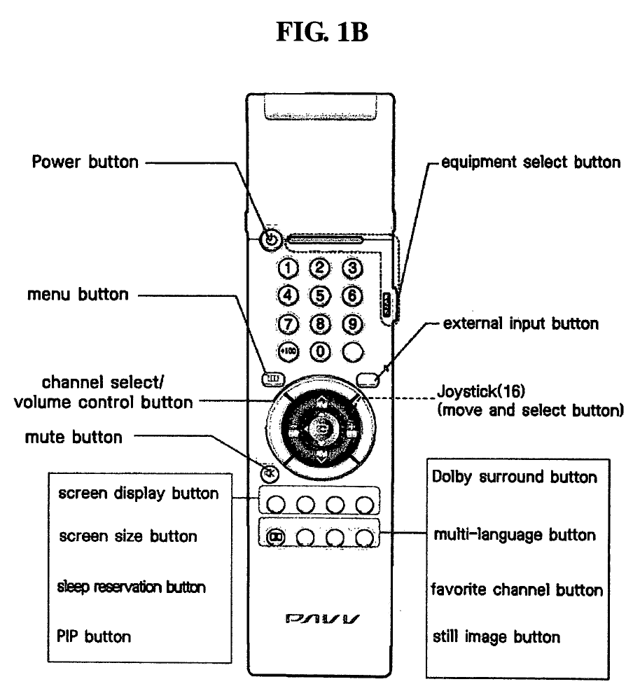

FIG. 1C is a view showing a conventional remote control device having a jog shuttle;

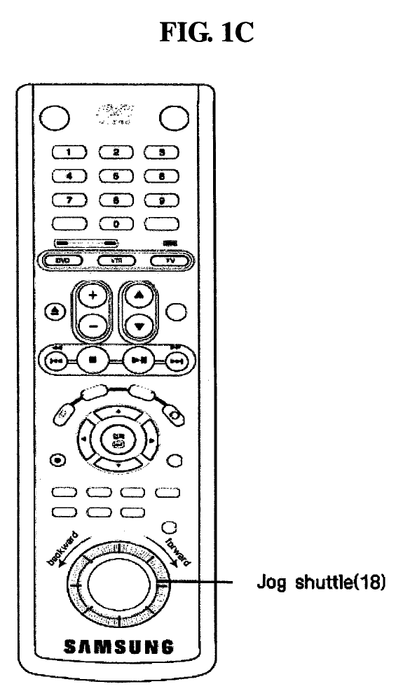

FIG. 1D is a view showing a conventional remote control device having a jog shuttle and a slider;

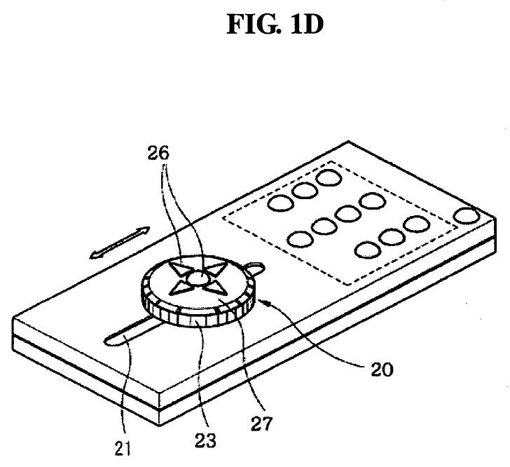

FIG. 2 is a view showing a conventional remote control device having a display and a ball switch;

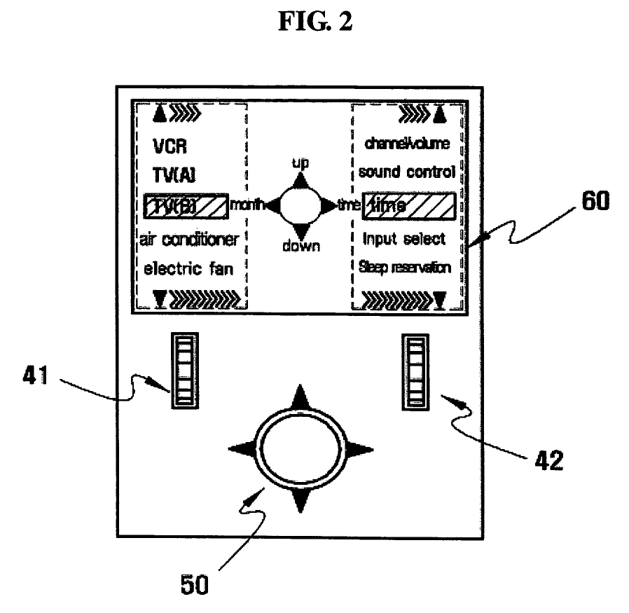

FIG. 3 is a view showing an appearance of a remote control device including a gear in accordance with an exemplary embodiment of the present invention;

FIG. 4 is a view showing a block diagram of a remote control device including a gear in accordance with an exemplary embodiment of the present invention;

FIG. 5 is a view showing an initial graphic user interface (GUI) to operate electronic equipment using a remote control device in accordance with an exemplary embodiment of the present invention; and

FIG. 6 is a flow chart showing a method for using a graphic user interface in accordance with an exemplary embodiment of the present invention.

### DETAILED DESCRIPTION OF EXEMPLARY NON-LIMITING EMBODIMENTS OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

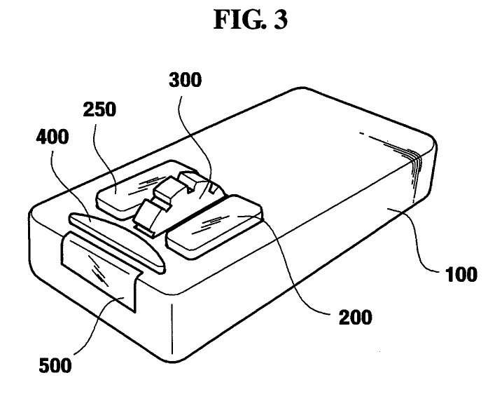

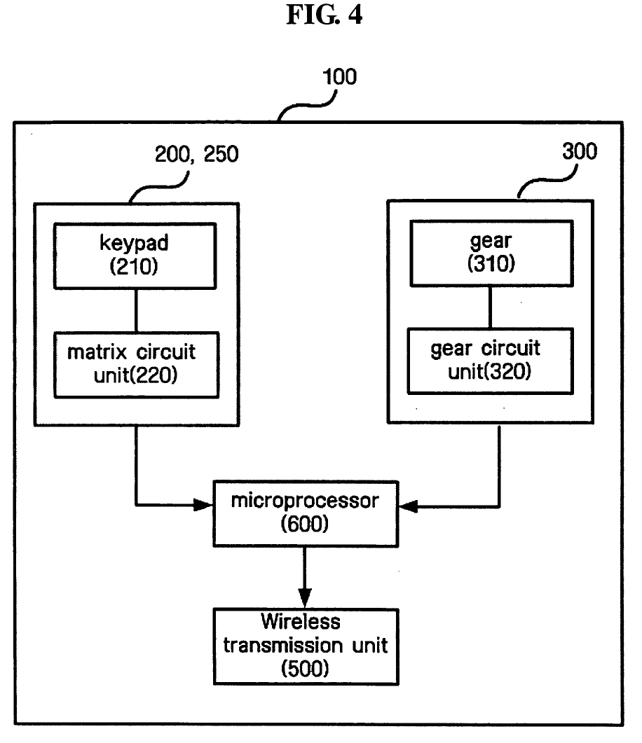

FIG. 3 is a view showing an appearance of a remote control device including a gear in accordance with an exemplary embodiment of the present invention, and FIG. 4 is a view showing a block diagram of a remote control device including a gear in accordance with an exemplary embodiment of the present invention.

The remote control device includes a body unit 100, a general button unit 200 and 250 having a keypad 210 and a matrix or keypad circuit part 220, a gear unit 300 having a gear 310 and a gear circuit part 320, a power source unit 400, a radio transmission unit 500 and a microprocessor 600.

Here, the general button unit 200 and 250 includes a first general button part 200 on one side of an upper part of the gear unit 300, and a second general button part 250 on the other side of the upper part of the gear unit 300. Of course, while it is no problem to have three or more buttons, an example having two buttons is explained in this embodiment and, as such, makes it easy to use the remote control device.

In an exemplary embodiment, the gear 310 has a similar construction and operating method as a general mouse including a wheel, such as a wheel button of a wheel mouse for a personal computer. That is, the gear 310 can be rotated in an up or down direction, or pushed and then returned. Such a gear may have a shape of a wheel or a circular sawtooth which have grooves at the edge of the wheel in a predetermined interval. Operations of the keypad 210 and gear 310 are transmitted from the radio transmission unit 500 to electronic equipment through the microprocessor 600 in the form of an infrared IR signal or a radio frequency RF signal.

A user receives the signal transmitted as described using electronic equipment including a radio receiver and operates a GUI on a screen through a display device such as a TV monitor. The GUI on the screen provides the user with a method for selecting one value among various values listed in one dimension such as a volume control, a channel change, an equipment selection, and an item selection on a menu item through an operation of the gear 310.

The first general button part 200 acts to select a menu item moved by the gear unit 300. And, the second general button part 250 acts to move a cursor among the GUIs in the case that the GUI of the electronic equipment is called or the number of the called GUI is more than two. Such construction plays a role similar to that of left and right buttons of a mouse of a general PC. It is regarded that, for example, the first general button part 200 corresponds to the left button of the PC mouse, and the second general button part 250 corresponds to the right button of the PC mouse.

On the other hand, the gear unit 300 acts to change a channel by a rotation operation according to a rotation direction of the gear 310, or to move a cursor or highlight to indicate an item being currently selected by the user among menu items listed on the GUI of the screen of the electronic equipment such as a volume control, a movement of a menu item and a screen scroll. At this time, the cursor or highlight can be established to move a predetermined interval whenever the gear has a specific rotation angle or the sawtooth of the gear moves one by one.

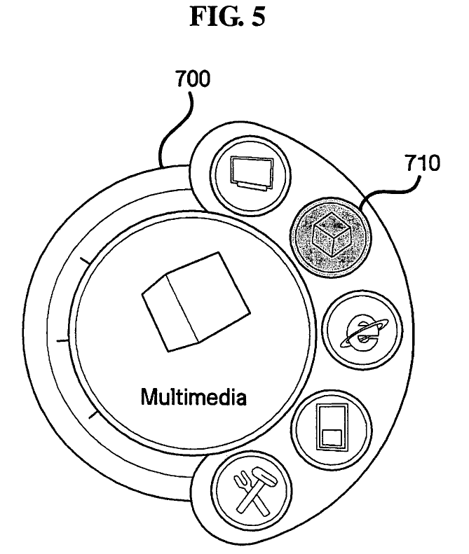

FIG. 5 is a view showing an initial GUI 700 to operate electronic equipment using a remote control device in accordance with an exemplary embodiment of the present invention. It can be understood that a cursor is placed on the second item 710 among the exemplary five menu items by a rotation operation of the gear 310, and such a selection can be performed by clicking the first general button part 200.

In the case that it takes a long time to make a movement among items by a high-speed rotation of the gear 310 since there are so many items on the GUI, it is possible to control a quantity of movement among the items on the GUI according to the rotation speed of the gear 310. For example, while the cursor or highlight indicating a movement among the items on the GUI moves one item after another one whenever the gear 310 rotates a predetermined angle or one groove of the gear in a general case, in the case that the rotation speed of the gear is fast, it may be possible that the movement of the cursor or highlight is established to move a plurality of items at once whenever the gear 310 rotates by one tooth.

In another exemplary embodiment where many items can be moved at a higher speed, it may be possible that when the user rotates the gear 310 once at a speed over a predetermined speed, the cursor or highlight continuously moves on the GUI for a predetermined time even though the user does not operate the gear 310 any more.

At this time, it may be possible that when the predetermined time elapses, a movement speed of the cursor or highlight is reduced gradually, or when the user operates the gear 310 or the first general button part 200 while the cursor or highlight moves, the cursor or highlight stops its movement and awaits to follow a user's operation.

Also, in the case that the items listed on the GUI are too numerous to be displayed on the screen, only some items are displayed and remaining items are hidden. At this time, it is possible to use a bubble button effect so that when the cursor or highlight moves to the end of the items displayed on the screen by the rotation of the gear 310, the hidden items appear on the screen.

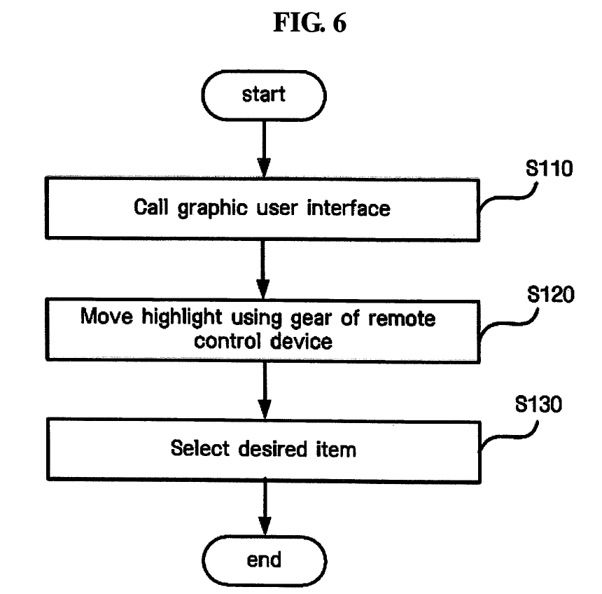

FIG. 6 is a flow chart showing a method for using a graphic user interface in accordance with an exemplary embodiment of the present invention.

When the user calls the graphic user interface using a general button unit of the remote control device (S110), a graphic user interface established previously is displayed. A desired item is displayed on the user interface, and items selected by the user are displayed by moving the cursor or highlight.

The user can move the cursor or highlight by rotating the gear included in the remote control device (S120), and select a desired item using the general button unit of the remote control device (S130).

In the method for using the graphic user interface, the movement of the cursor or highlight can be controlled by a rotation speed, a rotation angle or a rotation direction of the remote control gear as described above.

Although exemplary embodiments and drawings of the present invention have been disclosed for illustrative purposes, those skilled in the art appreciate that various substitutions, modifications, changes and additions are possible, without departing from the scope and spirit of the invention as disclosed in the accompanying claims.

According to the embodiments of the present invention constructed as described above, when a user wishes to select a desired value by rotating a wheel button one by one, it is possible to control its speed, wherein the user can perform a precise position movement one by one when moving at a slow speed, and can operate the button conveniently when moving at a high speed. That is, in the case of a satellite broadcasting where there are hundreds of channels, the user can assign the value while controlling the speed in order to assign a user's desired value among hundreds of sequential values if the user uses a wheel button instead of an up and down control button or a number button.

1. A remote control device, comprising:
a general button unit including a keypad and a keypad circuit part which outputs a signal according to an operation of the keypad;
a gear unit including a rotary gear and a gear circuit part which outputs a signal according to a rotation operation of the rotary gear;
a control unit which generates an electronic equipment control signal according to the signal outputted from the keypad circuit part and the signal outputted from the gear circuit part; and
a transmission unit which externally transmits the signal generated in the control unit.

2. The device according to claim 1, wherein the gear is shaped as a wheel.

3. The device according to claim 2, wherein the gear has teeth.

4. The device according to claim 2, wherein the general button unit includes a first general button part at one side of an upper part of the gear unit and a second general button part at another side of the upper part of the gear unit.

5. The device according to claim 4, wherein the first general button unit acts to select a menu for controlling an operational state of controlled equipment or to select an item on a graphic user interface, and the second button unit acts to call the menu or the graphic user interface.

6. The device according to claim 5, wherein the gear unit moves a curser or a highlight among the menu or items listed on the graphic user interface according to a rotation direction of the gear.

7. The device according to claim 5, wherein the gear unit performs a channel change, a volume control or a screen scroll of the controlled equipment according to a rotation direction of the gear.

8. The device according to claim 6 or claim 7, wherein the wheel includes teeth, and the cursor or highlight moves by a predetermined interval whenever the gear has a specific rotation angle or the teeth of the gear move by one.

9. The device according to claim 8, wherein a movement interval of the cursor or highlight is changed as a rotation speed of the gear changes.

10. The device according to claim 9, wherein, in the case that an instantaneous rotation speed of the gear exceeds a threshold value, the cursor or highlight continues to move even after there is no more rotation movement of the gear.

11. The device according to claim 10, wherein the movement of the cursor or highlight is stopped when the gear is pushed or after a lapse of a predetermined time.

12. The device according to claim 6, wherein, when the cursor or highlight moves to an end of the menu or to an end of the items listed on the graphic user interface as the gear rotates, hidden items which are not displayed on the menu or graphic user interface are displayed.

13. A method for using a graphic user interface, the method comprising the steps of:
providing a remote control device including a gear;
calling the graphic user interface;
enabling a cursor or highlight to move among items of the graphic user interface according to a rotational direction of the gear; and
selecting a desired item.

14. The method according to claim 13, wherein the cursor or highlight moves by a predetermined interval whenever the gear has a specific rotation angle or teeth of the gear move by one.

15. The method according to claim 14, wherein a movement interval of the cursor or highlight is changed as a rotation speed of the gear changes.

16. The method according to claim 15, wherein, in the case that an instantaneous rotation speed of the gear exceeds a threshold value, the cursor or highlight continues to move even after there is no more rotation movement of the gear.

17. The method according to claim 16, wherein the movement of the cursor or highlight is stopped when the gear is pushed or after a lapse of a predetermined time.

18. The method according to claim 13, wherein, the cursor or highlight moves through a menu or items listed on a graphic user interface as the gear rotates, such that when the cursor or highlight moves to an end of the menu or to an end of the items listed on the graphic user interface, hidden items which were not displayed on the menu or graphic user interface are then displayed.
